(19) United States
(12) Patent Application Publication
(10) Pub. No.: US 2011/0151244 A1
(43) Pub. Date: Jun. 23, 2011

(54) COATING COMPOSITIONS HAVING IMPROVED SOLAR REFLECTIVITY AND UV PROTECTION

(75) Inventors: Dan Qing Wu, West Chester, PA (US); Joy Sawyer Bloom, Wilmington, DE (US); John D. Connolly, JR., Wilmington, DE (US)

(73) Assignee: E.I. DU PONT DE NEMOURS AND COMPANY, Wilmington, DE (US)

(21) Appl. No.: 13/060,361

(22) PCT Filed: Sep. 29, 2009
(86) PCT No.: PCT/US09/58691

§ 371 Date: Feb. 23, 2011

Related U.S. Application Data
(60) Provisional application No. 61/100,977, filed on Sep. 29, 2008.

(51) Int. Cl. B32B 25/02; B32B 5/16; C08K 3/22; C09D 1/00

(52) U.S. Cl. 428/325; 524/497; 106/287.19; 106/287.16

(57) ABSTRACT

The disclosure provides a coating composition for outdoor applications having improved solar reflectivity and UV protection comprising a coating base, wherein the coating base comprises: (a) a colorant; and (b) an ultrafine-TiO₂ having a median primary particle size (MPPS) of greater than about 70 nm.

### BACKGROUND OF THE DISCLOSURE

1. Field of the Disclosure

The present disclosure relates to coating compositions comprising inorganic powders, in the ultrafine particle size range, in combination with colorants such as color pigments, and more particularly to coating compositions having improved solar reflectivity and UV protection.

2. Description of the Related Art

The coating compositions of interest in the present disclosure are water-dispersible coating compositions such as latex coating compositions, e.g. acrylic, styrene acrylic, etc; and solvent based such as alkyd coating compositions; urethane coating compositions; and unsaturated polyester coating compositions, typically a paint, clear coating, or stain. These coatings may be applied to a substrate by spraying, applying with a brush or roller or electrostatically, such as powder coatings, etc. These coating compositions are described in Outlines of Paint Technology (Halstead Press, New York, N.Y., Third edition, 1990) and Surface Coatings Vol. I, Raw Materials and Their Usage (Chapman and Hall, New York, N.Y., Second Edition, 1984).

Inorganic powders may be added to the coating compositions. In particular, titanium dioxide pigments, have been added to coating compositions for imparting whiteness and/or opacity to the finished article.

In warm climates a substantial amount of energy is expended in keeping the interior of buildings cool. One way to reduce the amount of energy expended is to employ energy saving coatings on buildings. Typically, these coatings help reduce heat gain when the weather is hot and reduce heat loss when the weather is cold,

A need exists for coating compositions, such as cool roof coatings, having improved solar reflectivity and UV protection.

### SUMMARY OF THE DISCLOSURE

In a first aspect, the disclosure provides a coating composition for outdoor applications having improved solar reflectivity and UV protection comprising a coating base, wherein the coating base comprises:
(a) a colorant; and
(b) an ultrafine-TiO₂ having a median primary particle size (MPPS) of greater than about 70 nm, more typically about 70 nm to about 135 nm, still more typically about 90 nm to about 120 nm.

By median primary particle size we mean average particle of a minimum of 500 particles as observed by high resolution scanning electron microscopy.

In the first aspect, the coating base further comprises a resin.

In the first aspect, the resin is selected from the group consisting of water-dispersible coating compositions such as latex coating compositions, and solvent based compositions such as alkyd coating compositions; urethane coating compositions; and unsaturated polyester coating compositions; and mixture thereof.

In a second aspect, the coating composition is a paint, and the paint is applied to a surface selected from the group consisting of building material, automobile part, sporting good, tenting fabric, tarpaulin, geo membrane, stadium seating, lawn furniture and roofing material.

### DETAILED DESCRIPTION OF THE DISCLOSURE

Coating compositions prepared from colorant and the ultrafine-TiO₂ containing coating bases have minimized light transmission in the UV portion of the spectra and show improvement regarding total solar reflectivity, wherein the impact on tint strength is substantially less than in pigmentary TiO₂ containing compositions.

### Coating Base:

The coating base comprises a dispersion of resin and colorants of this disclosure. Other additives known to one skilled in the art may also be present.

### Resin:

The resin is selected from the group consisting of water-dispersible coating compositions such as latex coating compositions; alkyd coating compositions; urethane coating compositions; and unsaturated polyester coating compositions; and mixture thereof. By “water-dispersible coatings” as used herein is meant surface coatings intended for the decoration or protection of a substrate, comprising essentially an emulsion, latex, or a suspension of a film-forming material dispersed in an aqueous phase, and typically comprising surfactants, protective colloids and thickeners, pigments and extender pigments, preservatives, fungicides, freeze-thaw stabilizers, antifoam agents, agents to control pH, coalescing aids, and other ingredients. Water-dispersed coatings are exemplified by, but not limited to, pigmented coatings such as latex paints. For latex paints the film forming material is a latex polymer of acrylic, styrene-acrylic, vinyl-acrylic, ethylene-vinyl acetate, vinyl acetate, alkyd, vinyl chloride, styrene-butadiene, vinyl versatate, vinyl acetate-maleate, or a mixture thereof. Such water-dispersed coating compositions are described by C. R. Martens in “Emulsion and Water-Soluble Paints and Coatings” (Reinhold Publishing Corporation, New York, N.Y., 1965). Tex-Cote® and Super-Cote® are further examples of water based coating compositions comprising 100% acrylic resin.

The alkyd resins may be complex branched and cross-linked polyesters having unsaturated aliphatic acid residues. Urethane resins typically comprise the reaction product of a polyisocyanate, usually toluene diisocyanate, and a polyhydric alcohol ester of drying oil acids.

The resin is present in the amount of about 10 to about 45% by weight based on the total weight of the coating composition. The amount of resin is varied depending on the amount of sheen finish desired.

### Colorant:

Any conventional colorant such as a pigment, dye or a dispersed dye may be used in this disclosure to impart color to the coating composition. In one embodiment, generally, about 0.1% to about 40% by weight of conventional pigments, based on the total weight of the component solids, can be added. More typically, about 0.1% to about 20% by weight of conventional pigments, based on the total weight of component solids, can be added.

The pigment component of this disclosure may be any of the generally well-known pigments or mixtures thereof used in coating formulations, as reported, e.g., in Pigment Handbook, T. C. Patton, Ed., Wiley-Interscience, New York, 1973. Any of the conventional pigments used in coating compositions can be utilized in these compositions such as the following: metallic oxides, such as titanium dioxide, zinc oxide, and iron oxide, metal hydroxide, metal flakes, such as aluminum flake, chromates, such as lead chromate, sulfides, sulfates, carbonates, carbon black, silica, talc, china clay, phthalocyanine blues and greens, organo reds, organo maroons, pearlescent pigments and other organic pigments and dyes. If desired chromate-free pigments, such as barium metaborate, zinc phosphate, aluminum triphosphate and mixtures thereof, can also be used.

Some useful pigments include C.I. Pigments: Black 12, Black 26, Black 28, Black 30, Blue 15.0, Blue 15.3 (G), Blue 15.3 (R), Blue 28, Blue 36, Blue 385, Brown 24, Brown 29, Brown 33, Brown 10P850, Green 7 (Y), Green 7 (B), Green 17, Green 26, Green 50, Violet 14, Violet 16, Yellow 1, Yellow 3, Yellow 12, Yellow 13, Yellow 14, Yellow 17, Yellow 62, Yellow 74, Yellow 83, Yellow 164, Yellow 53, Red 2, Red 3(Y), Red 3 (B), Red 4, Red 48.1, Red 48.2, Red 48.3, Red 48.4, Red 52.2, Red 49.1, Red 53.1, Red 57.1(Y), Red 57.1(B), Red 112, Red 146, Red 170(F5RK Type) Bluer, C.I. Pigment Orange 5, Pigment Orange 13, Pigment Orange 34, Pigment Orange 23 (R), and Pigment Orange 23 (B). Some useful organic pigments include: Pigment Yellow 151, Pigment Yellow 154, Pigment Yellow 155, Pigment Red 8, Pigment Red 8, Pigment Red 49.2, Pigment Red 81, Pigment Red 169, Pigment Blue 1, Pigment Violet 1, Pigment Violet 3, Pigment Violet 27, Pigment Red 122, Pigment Violet 19. Some useful inorganic pigments include: Middle Chrome, Lemon Chrome, Prime-Rose Chrome, Scarlet Chrome, and Zinc Chromate.

More typical pigments include: Black 12, Black 26, Black 28, Black 30, Blue 28, Blue 36, Blue 385, Brown 24, Brown 29, Brown 33, Green 17, Green 26, Green 50, Violet 14, Violet 16, Yellow 164 and Yellow 53.

Heat reflective pigments, also known as cool pigments or infrared (IR) pigments, that are made of metal oxide or ceramics, may also be used in these coating compositions. Typical heat reflective pigments of this disclosure are sold by Ferro Corporation (Cleveland, Ohio) as Cool Colors™ & Eclipse™ pigments. Exemplary IR reflective pigments sold by Ferro Corporation include “new black” (Ferro product no. V-799), “old black” (Ferro product no. V-797), “turquoise” (Ferro product no. PC-5686), “blue” (Ferro product no. PC-9250), “camouflage green” (Ferro product no. V-12600), “IR green” (Ferro product no. V-12650), “autumn gold” (Ferro product no. PC9158), “yellow” (Ferro product no. PC-9416), and “red” (Ferro product nos. V-13810 and V-13815).

Some additional typical cool pigments include: C.I. Pigment Blue 385, C.I. Pigment Brown 10P850, 0.1 Pigment Black 10P922, Filofin®Red BR-PP, Irgalite® Blue BSP.

These pigments may be obtained from Shepherd Color, Cincinnati, Ohio, Ciba, High Point, N.C. and MetroChem Corporation, Umraya, India.

### Ultrafine TiO₂:

In particular, titanium dioxide is an especially useful powder in the processes and products of this disclosure. Titanium dioxide (TiO₂) powder useful in the present disclosure may be in the rutile or anatase crystalline form. It is commonly made by either a chloride process or a sulfate process. In the chloride process, TiCl₄ is oxidized to TiO₂ powders. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The powder may be pigmentary, nano or ultrafine particles. Pigmentary refers to median primary particles in the size range typically about 200 nm to about 450 nm, and nano refers to median primary particles in the size range typically less than 50 nm.

By “ultrafine particle” it is meant that the titanium dioxide powders typically have a median primary particle size (MPPS) of greater than about 70 nm, more typically about 70 nm to about 135 nm and more typically about 90 nm to about 120 nm, as determined by utilizing high resolution scanning electron microscopy (HRSEM). By median primary particle size we mean average particle of a minimum of 500 particles as measured by HRSEM. The ultrafine particles of this disclosure typically are substantially polyhedral in shape and have an aspect ratio between about 1 and about 3 and more typically about 1 to about 2. The process for manufacturing the ultrafine particles of this disclosure is outlined in detail in U.S. Pat. Nos. 7,276,231 issued Oct. 2, 2007, and 7,208,126 issued Apr. 24, 2007, the disclosures of which are incorporated herein by reference.

As shown in Table 1, the ultrafine TiO₂ of this disclosure, DuPont™ Light Stabilizer 210 (DLS-210) has a median primary particle size of 103 nm, that is more than 2 times larger than that of known nano-sized titanium dioxide powders, UV Titan P190 and L530 obtained from Kemira, and Hombitec RM-130F obtained from Sachtleben. The table also lists the median primary particle size of Ti-Pure® R-101, obtained from DuPont Titanium Technologies. R-101 is a pigmentary grade of TiO₂. DLS-210 has a median primary particle size that is approximately 2 times smaller than R-101.

TABLE 1
Median Primary Particle Size of TIO₂

| | Median Primary |
|---|---|
| Titanium Dioxide | Particle Size (nm) |
| R-101 | 198 |
| DLS-210 | 103 |
| P190 | 36 |
| L530 | 38 |
| RM-130F | 40 |

The median primary particle size in Table 1 was determined by utilizing high resolution scanning electron microscopy (HRSEM). The median primary particle size is defined as the average value of all the particles measured.

Opacity is another distinguishing feature between pigmentary and ultrafine and nano-sized particles. Opacity in polymeric products, such as a coating, is a function of bending the optical path of white light such that its path is reversed and returns to the eye of the viewer. The alteration of the optical path is accomplished by maximizing the difference of the index of refraction of the fillers and the index of refraction of the polymer matrix they are dispersed in. TiO₂ is the highest refractive index of known fillers and hence provides the maximum difference in refractive index when combined with any polymer. The interaction of light with fillers is very strongly influenced by the particle size of the filler, and is maximized when the filler particle is sized to be ½ the wavelength of the incoming light radiation. For visible white light, this size range is about 200 nm to about 400 nm. Particles smaller than about 200 nm decreasingly interact with visible light, and these particles interact more strongly with ultraviolet light. Particles less than about 50 nm (nano) are too small to interact with visible light and will have minimal contribution to opacity. Particles in the size range of about 50 nm to about 200 nm (ultrafine) will have an increased chance of refracting some visible components of light and hence will have a contribution to opacity.

As shown in Table 2, both nano sized TiO₂ samples (P190 and RM-130F) showed higher light transmission at 400 nm than both ultrafine (DLS-210) and pigmentary TiO₂ (DuPont Ti-Pure® R-105) samples. It is known that light attenuation, as expressed by absorbance is dependent on both absorption and scattering. It is also known that TiO₂ absorbs light at wavelengths that are shorter than 405 nm and light absorption of TiO₂ is insignificant in visible and near IR regions. Therefore in the visible and near IR light regions, light attenuation is dependent primarily on light scattering. Hence according to the data in Table 2 one would expect the nano-sized TiO₂ particles to be significantly less effective in the scattering of visible and near IR light than either the ultrafine or the pigmentary TiO₂. As light reflection is strongly related to light scattering, one would also expect that nano sized TiO₂ particles would be less effective than both ultrafine and pigmentary TiO₂ particles in solar reflective capability.

As a UV stabilizer, TiO₂ particles absorb and scatter UV light. One would expect that nano-sized TiO₂ would be more effective in UV absorption than ultrafine TiO₂ particles, as nano-sized TiO₂ have a much higher specific surface area than either ultrafine or pigmentary TiO₂. On the other hand, one would also expect that nano-sized TiO₂ particles would be less effective in scattering of UV light, particularly, in the UV-A region (320-400 nm) than ultrafine TiO₂ as ultrafine TiO₂ has a particle size closer to ½ of the UV wavelength than nano-sized TiO₂. Table 2 illustrates that DLS-210, an ultrafine TiO₂, is better in blocking UV-A than two nano-sized TiO₂ (RM-130F and P190). The nano-sized TiO₂, however, is more effective in blocking UV-B than the ultrafine TiO₂. It's not surprising to observe that R-105, a pigmentary grade of TiO₂, is inferior in UV blocking (both UV-A and UV-B) than both nano-sized and ultrafine TiO₂.

TABLE 2
UV Blocking of TiO₂***

| Titanium | | Wavelength* | | | |
|---|---|---|---|---|---|
| Dioxide | | 250 nm | 300 nm | 350 nm | 400 nm |
| DLS-210 | Absorbance** | 1.020 | 1.173 | 1.384 | 0.277 |
| | % transmission | 10.0 | 6.9 | 4.1 | 52.8 |
| R-105 | Absorbance | 0.629 | 0.687 | 0.735 | 0.323 |
| | % transmission | 23.5 | 20.5 | 18.4 | 47.5 |
| RM-130F | Absorbance | 2.099 | 2.374 | 0.582 | 0.099 |
| | % transmission | 0.7 | 0.42 | 26.2 | 79.6 |
| P190 | Absorbance | 1.873 | 2.087 | 0.791 | 0.138 |
| | % transmission | 1.34 | 0.82 | 16.2 | 72.9 |

*UV-B: 290-320 nm; UV-A: 320-400 nm; visible: 400-760 nm
**Absorbance = - LOG (% transmission/100)
***Tested in 50 μm thick low density polyethylene films with 1% TiO₂ loading

The titanium dioxide powder may be substantially pure titanium dioxide or may contain other metal oxides, such as silica, alumina, zirconia. Other metal oxides may become incorporated into the powders, for example, by co-oxidizing or co-precipitating titanium compounds with other metal compounds. If co-oxidized or co-precipitated, the treatment is about 20 wt % of the metal oxide, more typically, about 0.5 to about 10 wt %, most typically about 0.5 to about 5 wt %, based on the total powder weight.

The titanium dioxide powder may also bear one or more metal oxide surface treatments. These treatments may be applied using techniques known by those skilled in the art. Examples of metal oxide treatments include silica, alumina, zirconia among others. Such treatments may be present in an amount of about 0.1 to about 10 wt %, based on the total weight of the powder.

The inorganic powder may be silanized by treating with at least one silane, or a mixture of at least one silane and at least one polysiloxane. The silane comprises a silane monomer. Suitable silane monomers are those in which at least one substituent group of the silane is contains an organic substituent. The organic substituent can contain heteroatoms such oxygen or halogen. Typical examples of suitable silanes include, without limit, alkoxy silanes and halosilanes having the general formula:

RₓSi(R′)₄₋ₓ

wherein

R is a nonhydrolyzable aliphatic, cycloaliphatic or aromatic group

having at least 1 to about 20 carbon atoms;

R′ is a hydrolyzable group such as an alkoxy, halogen, acetoxy or hydroxy or mixtures thereof; and

x=1 to 3.

Typically R is a nonhydrolyzable aliphatic group of the structure:

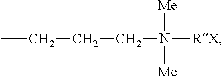

wherein R″ is a C1-C20 hydrocarbon, and X═Cl, Br, or HSO₄; and R′ is a hydrolyzable group such as an alkoxy, halogen, acetoxy or hydroxy or mixtures thereof; and x=1 to 3.

Some useful silanes may be selected from the group of 3-trimethoxysilyl propyl octyl dimethyl ammonium chloride, 3-trimethoxysilyl propyl octyl dimethyl ammonium chloride, 3-trimethoxysilyl propyl decyl dimethyl ammonium chloride, 3-trimethoxysilyl propyl hexadecyl dimethyl ammonium chloride, and 3-trimethoxysilyl propyl octadecyl dimethyl ammonium chloride.

Alternately, a siloxane may be used in combination with the silane to surface treat the inorganic powder. Typically, the siloxane may have a reactive site, and a silicon-hydrogen bond may form the reactive site of the siloxane polymer. Hydridosiloxanes are typical examples of useful siloxanes having a silicon-hydrogen reactive site. Such hydridosiloxanes include alkylhydridosiloxanes in which the alkyl group contains from 1 to about 20 carbon atoms. Specifically methylhydridosiloxanes can be useful such as those having the formula Me₃SiO[SiOMeH]ₙ—[SiOMe₂]ₘ—SiMe₃, where n and m are independently integers from 1 to about 200 and Me is methyl. Other potentially useful siloxane compounds having a reactive site are the hydridosilsesquioxanes described in U.S. Pat. No. 6,572,974.

The silane or combination of silane and siloxane may be present in the amount of about 0.1 to about 10 weight %, based on the total amount of the treated powder.

Alternately, the inorganic powder may be surface treated with hydrocarbon based surface treatments such as fatty acids, trimethylol propane (TMP), triethyl amine (TEA), etc. Additionally the inorganic powder may be surface treated with organo-phosphonates, organo-phosphoric acid compounds, organo-acid phosphates, organo-phosphinates, organo-sulfonic compounds, etc.

By “surface treated” it is meant inorganic powders, in particular titanium dioxide powders, that have been contacted with the compounds described herein wherein the compounds are adsorbed on the surface of the powder or a reaction product of at least one of the compounds with the powder is present on the surface as an adsorbed species or chemically bonded to the surface. The compounds or their reaction products or combination thereof may be present as a coating, continuous or discontinuous, on the surface of the powder. Typically, a continuous coating comprising the silane; siloxane; hydrocarbon based surface treatments such as trimethylol propane (TMP), triethyl amine (TEA), and fatty acids; organo-phosphonates; organo-phosphoric acid compounds; organo-acid phosphates; organo-phosphinates; organo-sulfonic compounds; or mixtures thereof, is on the surface of the powder.

The silanized inorganic powders may be prepared by a process that comprises surface treating powders with the silane or combination of silane and siloxane. This process is not especially critical and may be accomplished in a number of ways. While typically the powder may be treated with the silane, if present, and then the siloxane compound in sequence, the powder may be treated with the silane and the siloxane compound simultaneously.

The surface treatment of the powder may be performed by contacting dry powder with neat compound or in an appropriate solvent that one skilled in the art can select. When a silane is employed the compound may be prehydrolzyed, then contacted with dry powder. Alternatively other methods may be used for treating particle surfaces such as v-cone, flow restrictor etc.

The ultrafine TiO₂ is present in the amount of about 0.1% to about 20% by weight, more typically about 0.5% to about 5% by weight, based on the weight of solids.

### Other Additives

A wide variety of additives may be present in the coating compositions of this disclosure as necessary, desirable or conventional. These compositions can further comprise various conventional paint additives, such as dispersing aids, anti-settling aids, wetting aids, thickening agents, extenders, plasticizers, stabilizers, light stabilizers, antifoams, defoamers, catalysts, texture-improving agents and/or antiflocculating agents. Conventional paint additives are well known and are described, for example, in “C-209 Additives for Paints” by George Innes, February 1998, the disclosure of which is incorporated herein by reference. The amounts of such additives are routinely optimized by the ordinary skilled artisan so as to achieve desired properties in the wall paint, such as thickness, texture, handling, and fluidity.

Coating compositions of the present disclosure may comprise various rheology modifiers or rheology additives (such as acrysol), wetting agents, defoamers, dispersants and/or co-dispersants, and microbicides and/or fungicides. To achieve enhanced weatherability, the present coating compositions may further comprise UV (ultra-violet) absorbers such as Tinuvin®.

Coating compositions of the present disclosure may further comprise ceramic or elastomeric substances, which are heat and/or infrared reflective, so as to provide additional heat reflective benefits.

### Preparation of the Coating Composition and its Use:

The present disclosure provides a process for preparing a coating composition, such as a paint formulation, comprising mixing the powder-containing components with the resin to form a coating base. Optionally a vehicle may be present. The vehicle may be aqueous or solvent based. Typically these coating compositions may comprise from about 35 to about 50% solids by weight and typically about 30% to about 40% solids by volume. Typically the coating compositions of this disclosure have a density of about 9.1 to about 10.8 pounds per gallon, more typically about 9.5 to about 10.5 pounds per gallon. Any mixing means known to one skilled in the art may be used to accomplish this mixing. An example of a mixing device includes a high speed Dispermat®, supplied by BYK-Gardner, Columbia, Md.

Coating compositions of the present disclosure may be applied by any means known to one skilled in the art, for example, by brush, roller, commercial grade airless sprayers, or electrostatically in a powder coating. Coating compositions presented herein may be applied as many times necessary so as to achieve sufficient coating on the coated surface, for example, an exterior wall. Typically, these coating compositions may be applied from about 2 mils to about 10 mils wet film thickness, which is equivalent to from about 1 to about 5 dry mils film thickness.

Coating compositions presented herein may be applied directly to surfaces or applied after surfaces are first coated with primers as known to one skilled in the art.

In an alternate embodiment, the disclosure provides a coating composition for applications exposed to light, such as outdoor applications, having improved solar reflectivity and UV protection comprising a coating base, wherein the coating base comprises an ultrafine-TiO₂ having a median primary particle size (MPPS) of greater than about 70 nm, more typically about 70 nm to about 135 nm, still more typically about 90 nm to about 120 nm.

The coating compositions of this disclosure may be a paint, and the paint may be applied to a surface selected from the group consisting of building material, automobile part, sporting good, tenting fabric, tarpaulin, geo membrane, stadium seating, lawn furniture and roofing material.

The examples which follow, description of illustrative and typical embodiments of the present disclosure are not intended to limit the scope of the disclosure. Various modifications, alternative constructions and equivalents may be employed without departing from the true spirit and scope of the appended claims. In one embodiment, the coating films may be substantially free of pigmentary titanium dioxide.

### EXAMPLES

### Example 1

### Preparation of Paint Samples

### Raw Materials:

DuPont™ Light Stabilizer 210 (DLS-210), an ultrafine grade of rutile titanium dioxide (TiO₂), was supplied by DuPont Titanium Technologies, Wilmington, Del. A 50% DLS-210 slurry was prepared by mixing equal amounts of DLS-210 powder and de-ionized water with 1.2% TKPP (tetrapotassium pyrophosphate, supplied by ICL Performance Products, St, Louis, Mo.) using Dispermat® AEC-5 high-speed mixer (BYK-Gardner, Columbia, Md.), @1,500 RPM, for 15 mins. TKPP was pre-dissolved in de-ionized water before mixing with DLS-210.

Tinuvin® 1130, a benzotriazole based organic UV light absorber was supplied by Ciba Specialty Chemicals, High Point, N.C.

Ti-Pure® R-706, a pigmentary grade of rutile titanium dioxide, was supplied by DuPont Titanium Technologies, Wilmington, Del., in a slurry form, which is marketed as Ti-Pure® R-746. R-706 has a median primary particle size that is similar to that of Ti-Pure® R-101 and Ti-Pure® R-105. R-706 differs from R-101 and R-105 only in surface modification of rutile TiO₂ crystal particles.

Base Paint: Behr Premium Plus® 8300, a glossy deep base acrylic paint, was purchased from a Home Depot store in Delaware, USA.

Blue Paint: 10% Colortrend@ Phthalo Blue (888-7214), supplied by Degussa, Parsippany, N.J., was mixed thoroughly with Base Paint.

Red Paint: 10% Aquatrend™ II—Exterior Red (878-0837), supplied by Degussa, Parsippany, N.J., was mixed thoroughly with Base Paint.

### Test Paint Samples:

Non-colored (clear) paint samples were prepared by mixing in various amounts of the DLS-210 slurry, Tinuvin® 1130, or Ti-Pure® R-746 to Base Paint.

Blue paint samples were prepared by mixing in various amounts of the DLS-210 slurry, Tinuvin® 1130, or Ti-Pure® R-746 to Blue Paint.

Red paint samples were prepared by mixing in various amounts of the DLS-210 slurry, Tinuvin® 1130, or Ti-Pure® R-746 to Red Paint.

### Test Paint Film Samples

Paint film samples were prepared using a modified Band Viscometer that applies 0.75 mil wet films precisely on both sides of a 1 mil (25 μm) thick Mylar® film. The coatings were then air dried for a minimum of 3 days prior to the measurement of optical properties.

### Example 2

### Solar Reflection Results

Solar reflection of the paint film samples was measured using Perkin-Elmer Lamda 900 UV-Vis-NIR Spectrometer, with wavelength 250 to 2,500 nm. Total Solar Reflection (TSR) was calculated using both ASTM E424 and ASTM E903 methods.

TABLE 3
Total Solar Reflection of Base Paint Films (Non-Colored)

| | TSR (using | % | TSR (using | % |
|---|---|---|---|---|
| Samples | ASTM E424) | Change | ASTM E903) | Change |
| Non-Colored | 8.8 | — | 8.8 | — |
| Control | | | | |
| 0.5% DLS-210 | 15.7 | 78 | 14.7 | 67 |
| 1.0% DLS-210 | 21.4 | 143 | 19.9 | 126 |
| 2.0% DLS-210 | 29.3 | 233 | 27.0 | 207 |
| 1.0% Tinuvin ® | 7.8 | −11 | 7.6 | −14 |
| 1130 | | | | |
| 1.0% Ti-Pure ® | 28.4 | 223 | 26.5 | 201 |
| R-706 | | | | |

TABLE 4
Total Solar Reflection of Blue Paint Films

| | TSR (using | % | TSR (using | % |
|---|---|---|---|---|
| Samples | ASTM E424) | Change | ASTM E903) | Change |
| Blue Control | 7.3 | — | 7.3 | — |
| 0.5% DLS-210 | 11.3 | 55 | 11.1 | 52 |
| 1.0% DLS-210 | 13.9 | 90 | 13.5 | 85 |
| 2.0% DLS-210 | 18 | 147 | 17.4 | 138 |
| 1.0% Tinuvin ® | 7.4 | 1 | 7.3 | 0 |
| 1130 | | | | |
| 1.0% Ti-Pure ® | 17.8 | 144 | 17.7 | 142 |
| R-706 | | | | |

TABLE 5
Total Solar Reflection of Red Paint Films

| | TSR (using | % | TSR (using | % |
|---|---|---|---|---|
| Samples | ASTM E424) | Change | ASTM E903) | Change |
| Red Control | 13.6 | — | 12.8 | — |
| 0.5% DLS-210 | 16.1 | 18 | 15.1 | 18 |
| 1.0% DLS-210 | 18.1 | 33 | 17.0 | 33 |
| 2.0% DLS-210 | 22.1 | 63 | 20.7 | 62 |
| 1.0% Tinuvin ® | 13.3 | −2 | 12.5 | −2 |
| 1130 | | | | |
| 1.0% Ti-Pure ® | 23.0 | 69 | 21.8 | 70 |
| R-706 | | | | |

Tables 3-5 show that DLS-210, an ultrafine grade of rutile TiO₂, improved solar reflection. The improvement of solar reflection of DLS-210 was a function of concentration showing higher solar reflection at higher concentrations. Tinuvin® 1130, which is a benzotriazole organic based UV absorber, did not aid in solar reflection. R-706, a pigmentary grade of TiO₂, which has a primary particle size that is about 2 times larger than that of DLS-210, was more effective for solar reflection than DLS-210. The improvement on solar reflection from DLS-210 was about 50% of R-706.

### Example 3

### UV Blocking Results

Transmittance of the paint film samples was measured using Perkin-Elmer Lamda 900 UV-Vis-NIR Spectrometer, with wavelength 250 to 2,500 nm. Absorbance in Tables 6-8, of each wavelength (290-400 nm) was first calculated by taking negative logarithm of the transmittance divided by 100. Then Total UV Absorbance, Total UV-A Absorbance, and Total UV-B Absorbance were determined by adding up individual absorbances at different wavelengths from 290-400 nm, 320-400 nm, and 290-320 nm, respectively.

TABLE 6
UV Absorbance of Base Paint Films (non-colored)

| | Total | | Total | | Total | |
|---|---|---|---|---|---|---|
| | UV | | UV-A | | UV-B | |
| | Ab- | | Ab- | | Ab- | |
| | sorb- | % | sorb- | % | sorb- | % |
| | ance | Change | ance | Change | ance | Change |
| | Wavelength Range | | | | | |
| | 290-400 | | 320-400 | | 290-320 | |
| Samples | nm | | nm | | nm | |
| Non-Colored | 54 | — | 7 | — | 47 | — |
| Control | | | | | | |
| 0.5% DLS-210 | 86 | 58% | 34 | 364% | 51 | 8% |
| 1.0% DLS-210 | 118 | 116% | 58 | 687% | 58 | 24% |
| 2.0% DLS-210 | 183 | 235% | 108 | 1362% | 72 | 55% |
| 1.0% Tinuvin ® | 126 | 132% | 55 | 641% | 70 | 50% |
| 1130 | | | | | | |
| 1.0% Ti-Pure ® | 94 | 73% | 40 | 441% | 53 | 14% |
| R-706 | | | | | | |

TABLE 7
UV Absorbance of Blue Paint Films

| | Total | | Total | | Total | |
|---|---|---|---|---|---|---|
| | UV | | UV-A | | UV-B | |
| | Ab- | | Ab- | | Ab- | |
| | sorb- | % | sorb- | % | sorb- | % |
| | ance | Change | ance | Change | ance | Change |
| | Wavelength Range | | | | | |
| | 290-400 | | 320-400 | | 290-320 | |
| Samples | nm | | nm | | nm | |
| Non-Colored | 145 | — | 75 | — | 68 | — |
| Control | | | | | | |
| 0.5% DLS-210 | 182 | 25% | 110 | 45% | 71 | 3% |
| 1.0% DLS-210 | 215 | 48% | 137 | 81% | 76 | 12% |
| 2.0% DLS-210 | 254 | 75% | 167 | 121% | 84 | 23% |
| 1.0% Tinuvin ® | 211 | 46% | 122 | 61% | 88 | 28% |
| 1130 | | | | | | |
| 1.0% Ti-Pure ® | 181 | 25% | 109 | 44% | 71 | 3% |
| R-706 | | | | | | |

TABLE 8
UV Absorbance of Red Paint Films

| | Total | | Total | | Total | |
|---|---|---|---|---|---|---|
| | UV | | UV-A | | UV-B | |
| | Ab- | | Ab- | | Ab- | |
| | sorb- | % | sorb- | % | sorb- | % |
| | ance | Change | ance | Change | ance | Change |
| | Wavelength Range | | | | | |
| | 290-400 | | 320-400 | | 290-320 | |
| Samples | nm | | nm | | nm | |
| Non-Colored | 216 | — | 122 | — | 101 | — |
| Control | | | | | | |
| 0.5% DLS-210 | 253 | 17% | 148 | 32% | 102 | 1% |
| 1.0% DLS-210 | 283 | 31% | 175 | 56% | 105 | 4% |
| 2.0% DLS-210 | 338 | 57% | 225 | 100% | 110 | 9% |
| 1.0% Tinuvin ® | 262 | 22% | 156 | 39% | 104 | 3% |
| 1130 | | | | | | |
| 1.0% Ti-Pure ® | 271 | 25% | 154 | 37% | 113 | 12% |
| R-706 | | | | | | |

Table 6 shows UV blocking (absorbance) data for the non-colored Paint film samples comprising Base Paint alone or with a component such as DLS-210, Tinuvin® 1130, or Ti-Pure® R-706, and includes total integrated UV absorbance (290-400 nm), total integrated UV absorbance over the UV-B range (290-320 nm), and total integrated UV absorbance over the UV-A range (320-400 nm). Percentage increases in UV absorbance are shown for all reported values. The Base Paint containing added DLS-210 samples showed more effective UV blocking than the Base Paint samples over the entire UV range studied (290-400 nm) but particularly in the UV-A region, 320 nm-400 nm. The effectiveness of DLS-210 as a UV absorber is a function of concentration. At 1% loading DLS-210 showed total UV blocking comparable to 1% Tinuvin® 1130, a well-known commercial UV absorber. The effectiveness of DLS-210 in the UV-A range was slightly higher than Tinuvin® 1130 and in the UV-B range was somewhat lower than Tinuvin® 1130. At 1% loading, DLS-210 showed higher UV blocking over the entire UV range than R-706, a pigmentary grade of rutile TiO₂.

Table 7 shows UV blocking (absorbance) data for the blue paint film samples. The blue paint film samples comprising added DLS-210 showed more effective UV blocking than the initial blue paint film samples over the entire UV range studied (290-400 nm) but particularly in the UV-A region, 320 nm-400 nm. The effectiveness of DLS-210 as a UV absorber was a function of concentration showing higher UV absorbance at higher concentrations. At 1% loading DLS-210 showed total UV blocking comparable to 1% Tinuvin® 1130, a well-known commercial organic UV absorber. The effectiveness of DLS-210 in the UV-A range was somewhat higher than Tinuvin® 1130 and in the UV-B range was somewhat lower than Tinuvin® 1130. At 1% loading, DLS-210 showed higher UV blocking over the entire UV range than R-706, a pigmentary grade of rutile TiO₂.

Table 8 shows UV blocking (absorbance) data for the red paint film samples. Paint film samples of the red paint formula comprising added DLS-210 showed more effective UV blocking than the initial red paint formula over the entire UV range studied (290-400 nm) but particularly in the UV-A region, 320 nm-400 nm. The effectiveness of DLS-210 as a UV absorber was a function of concentration and showed higher UV absorbance at higher concentrations. The paint film sample of the red paint formulation comprising 1% DLS-210 showed total UV blocking greater than the paint film sample of the red paint formulation comprising 1% Tinuvin® 1130, a well-known commercial UV absorber. The effectiveness of DLS-210 in the UV-A range was significantly higher than Tinuvin® 1130 and in the UV-B range is comparable to Tinuvin® 1130. At 1% TiO₂ loading, the paint film sample of the red paint formulation comprising added DLS-210 showed higher UV blocking in the UV-A range than the film sample of the same red paint formulation comprising R-706. However, the red paint film sample comprising 1% R-706 showed higher UV blocking in UV-B range than the red film sample comprising 1% DLS-210.

What is claimed is:

1. A coating composition for outdoor applications having improved solar reflectivity and UV protection comprising a coating base, wherein the coating base comprises:
(a) a colorant; and
(b) an ultrafine-TiO₂ having a median primary particle size (MPPS) of greater than about 70 nm.

2. The coating composition of claim 1 wherein the median primary particle size (MPPS) is about 70 nm to about 135 nm.

3. The coating composition of claim 1 wherein the median primary particle size (MPPS) is about 90 nm to about 120 nm.

4. The coating composition of claim 1 wherein the coating base further comprises a resin.

5. The coating composition of claim 4 wherein the resin is selected from the group consisting of a water-dispersible coating composition, solvent based composition, and mixture thereof.

6. The coating composition of claim 5 wherein the water-dispersible coating composition comprises a latex polymer.

7. The coating composition of claim 6 wherein the latex polymer is selected from the group consisting of acrylic, styrene-acrylic, vinyl-acrylic, ethylene-vinyl acetate, vinyl acetate, alkyd, vinyl chloride, styrene-butadiene, vinyl versatate, vinyl acetate-maleate, and mixtures thereof.

8. The coating composition of claim 5 wherein the solvent based composition is selected from the group consisting of an alkyd coating composition; a urethane coating composition; and an unsaturated polyester coating composition.

9. The coating composition of claim 4 wherein the resin is present in the amount of about 10 to about 45% by weight based on the total weight of the coating composition.

10. The coating composition of claim 1 wherein the colorant is a colored pigment, a dye or a dispersed dye.

11. The coating composition of claim 10 wherein the colorant is a colored pigment.

12. The coating composition of claim 10 wherein the colorant is present in the amount of about 0.1% to about 40% by weight, based on the total weight of the solids.

13. The coating composition of claim 10 wherein the colorant is selected from the group consisting of C.I. Pigments: Black 12, Black 26, Black 28, Black 30, Blue 15.0, Blue 15.3 (G), Blue 15.3 (R), Blue 28, Blue 36, Blue 385, Brown 24, Brown 29, Brown 33, Brown 10P850, Green 7 (Y), Green 7 (B), Green 17, Green 26, Green 50, Violet 14, Violet 16, Yellow 1, Yellow 3, Yellow 12, Yellow 13, Yellow 14, Yellow 17, Yellow 62, Yellow 74, Yellow 83, Yellow 164, Yellow 53, Red 2, Red 3(Y), Red 3 (B), Red 4, Red 48.1, Red 48.2, Red 48.3, Red 48.4, Red 52.2, Red 49.1, Red 53.1, Red 57.1(Y), Red 57.1(B), Red 112, Red 146, Red 170(F5RK Type) Bluer, C.I. Pigment Orange 5, Pigment Orange 13, Pigment Orange 34, Pigment Orange 23 (R), Pigment Orange 23 (B), and mixtures thereof.

14. The coating composition of claim 10 wherein the colorant is an organic pigment selected from the group consisting of Pigment Yellow 151, Pigment Yellow 154, Pigment Yellow 155, Pigment Red 8, Pigment Red 8, Pigment Red 49.2, Pigment Red 81, Pigment Red 169, Pigment Blue 1, Pigment Violet 1, Pigment Violet 3, Pigment Violet 27, Pigment Red 122, Pigment Violet 19, and mixtures thereof.

15. The coating composition of claim 10 wherein the colorant is an inorganic pigment selected from the group consisting of Middle Chrome, Lemon Chrome, Prime-Rose Chrome, Scarlet Chrome, Zinc Chromate, and mixtures thereof.

16. The coating composition of claim 10 wherein the colorant is selected from the group consisting of C.I. Pigments: Black 12, Black 26, Black 28, Black 30, Blue 28, Blue 36, Blue 385, Brown 24, Brown 29, Brown 33, Green 17, Green 26, Green 50, Violet 14, Violet 16, Yellow 164 and Yellow 53.

17. The coating composition of claim 10 wherein the colorant is a cool roof pigment selected from the group consisting of C.I. Pigment Blue 385, C.I. Pigment Brown 10P850, C.I. Pigment Black 10P922, Filofin® Red BR-PP, Irgalite® Blue BSP, heat reflective pigment made of metal oxide, heat reflective pigment made of ceramic, “new black” (Ferro product no. I V-799), “old black” (Ferro product no. V-797), “turquoise” (Ferro product no. PC-5686), “blue” (Ferro product no. PC-9250), “camouflage green” (Ferro product no. V-12650), “IR green” (Ferro product no. V-12650),I “autumn gold” (Ferro product no. PC9158), “yellow” (Ferro product no PC-9416) and “red” (Ferro product nos. V-13810 and V-13815).

18. The coating composition of claim 1 wherein the ultrafine TiO₂ is polyhedral in shape and has an aspect ratio of 1 to about 3.

19. The coating composition of claim 18 wherein the ultrafine TiO₂ is polyhedral in shape and has an aspect ratio of 1 to about 2.

20. The coating composition of claim 1 wherein the ultrafine TiO₂ is surface treated.

21. The coating composition of claim 20 wherein the surface treatment is with a metal oxide or mixtures of metal oxides.

22. The coating composition of claim 20 wherein the surface treatment is selected from the group consisting of silane, siloxane, hydrocarbon-based surface treatments, organo-phosphonates, organo-phosphoric acid compounds, organo-acid phosphates, organo-phosphinates, organo-sulfonic compounds, and mixtures thereof.

23. The coating composition of claim 1 wherein the ultrafine TiO₂ is present in the amount of about 0.1% to about 20% by weight, based on the weight of the solids.

24. The coating composition of claim 1 wherein the colorant is present in the amount of about 0.1% to about 40% by weight, based on the total weight of the solids.

25. The coating composition of claim 1 wherein the coating composition is a paint.

26. The coating composition of claim 25 wherein the paint is applied to a surface selected from the group consisting of building material, automobile part, sporting good, tenting fabric, tarpaulin, geo membrane, stadium seating, lawn furniture and roofing material.

27. A coating composition for outdoor applications having improved solar reflectivity and UV protection comprising a coating base, wherein the coating base comprises an ultrafine-TiO₂ having a median primary particle size (MPPS) of greater than about 70 nm.

28. A wall comprising a coating composition, wherein the coating composition has improved solar reflectivity and UV protection and comprises a coating base, wherein the coating base comprises:
(a) a colorant; and
(b) an ultrafine TiO₂ having a median primary particle size (MPPS) of greater than about 70 nm.

29. A roof comprising a coating composition, wherein the coating composition has improved solar reflectivity and UV protection and comprises a coating base, wherein the coating base comprises:
(a) a colorant; and
(b) an ultrafine TiO₂ having a median primary particle size (MPPS) of greater than about 70 nm.
